(19) United States
(12) Patent Application Publication
(10) Pub. No.: US 2007/0127200 A1
(43) Pub. Date: Jun. 7, 2007

(54) Portable computer

(75) Inventors: Szu-Wei Kuo, Tu-Cheng (TW); Juan Li, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/518,264

(22) Filed: Sep. 7, 2006

(30) Foreign Application Priority Data
Dec. 1, 2005 (CN) 200520119948.5

(51) Int. Cl. G06F 1/16

(52) U.S. Cl. 361/683

(57) ABSTRACT

A portable computer includes a cover unit, a base unit connectable to the cover unit, and a connector. The connector is disposed in a top portion of the base unit and accessible from a top surface of the base unit for electrically connecting with an external device.

### CROSS-REFERENCES TO RELATED APPLICATION

Relevant subject matter is disclosed in the co-pending U.S. patent application filed on the same date and entitled “DOCKING STATION FOR PORTABLE COMPUTER” with Attorney Docket No. US9350, which is assigned to the same assignee with this patent application.

### BACKGROUND OF THE INVENTION

1. Field of the Invention

The present invention relates to a portable computer, and more particularly to a portable computer with a docking station.

2. Description of related art

With the development of computer technology, use of portable computers has become widespread because of their relatively small size and portability. However, to achieve small-sized portable computers, many typically included expansion ports are not included, and so expandability of the portable computer is thus impaired. To compensate for the impaired expandability, the portable computer is typically provided with a docking station via which the portable computer may be connected with a mouse, a modem, and/or other peripheral equipment.

As disclosed in Taiwan Patent No. 568419, a docking station detachably connected to a bottom of a portable computer includes a base having a connector, and a cover. The cover is fixed to the base, and the connector extends outwardly from the cover to electrically connect with a socket on a bottom of the portable computer. Because the socket is installed in the bottom of the portable computer, the portable computer has to be manually moved to be attached to or detached from the docking station when in use, and vibration generated in attachment or detachment to or from the docking station may damage the portable computer.

What is needed, therefore, is a portable computer removably connectable to a docking station, without necessitating movement of the portable computer.

### SUMMARY OF THE INVENTION

An exemplary portable computer includes a cover unit, a base unit connectable to the cover unit, and a connector. The connector is disposed in a top portion of the base unit and accessible from a top surface of the base unit for electrically connecting with an external device.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an exploded, isometric view of a portable computer with a docking station in accordance with a preferred embodiment of the present invention;

FIG. 2 is similar to FIG. 1, but the docking station is replaced by a lid;

FIG. 3 is a front elevational view of the docking station of FIG. 1; and

FIG. 4 is an assembled view of FIG. 1.

### DETAILED DESCRIPTION OF THE INVENTION

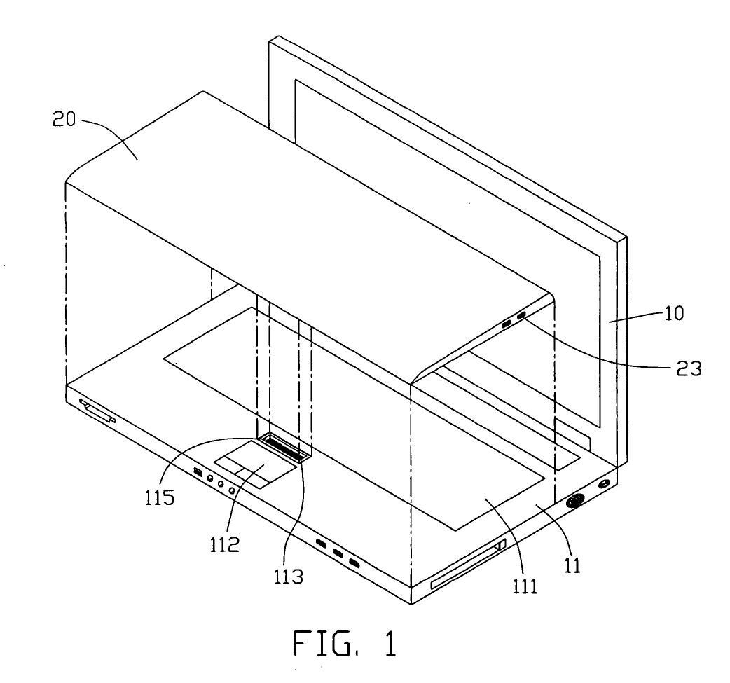

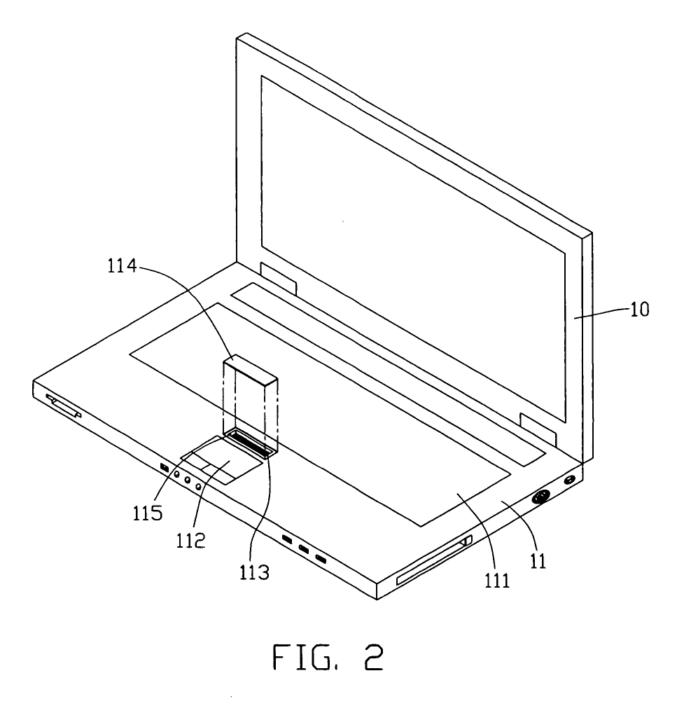

Referring to FIGS. 1 and 2, a portable computer is provided in accordance with a preferred embodiment of the present invention. The portable computer includes a cover unit 10, a base unit 11 pivotally connected to the cover unit 10, and a docking station 20.

The base unit 11 includes a keyboard 111 and a touchpad 112. A recess 115 is defined in a top portion of the base unit 11, and a connector 113 is disposed in the base unit 11 and exposed from the recess 115 of the base unit 11. The base unit 11 includes a lid 114 removably covering the recess 115 of the base unit 11, for protecting the connector 113 from dust and damaging contact.

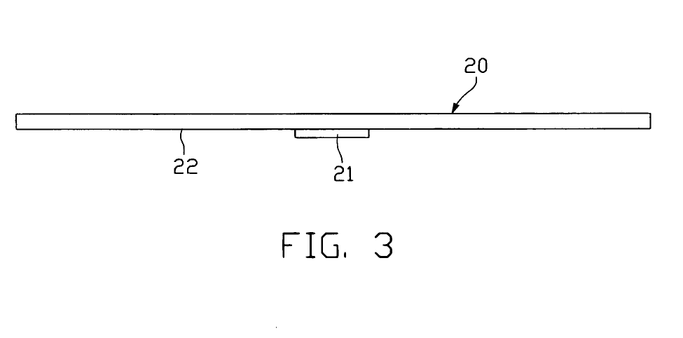

Referring also to FIG. 3, the docking station 20 includes a connector 21 protruding from a bottom 22 of the docking station 20. A plurality of ports 23 is disposed in sidewalls of the docking station 20, for connecting peripheral equipment such as a keyboard, a scanner, and a printer to achieve additional functions.

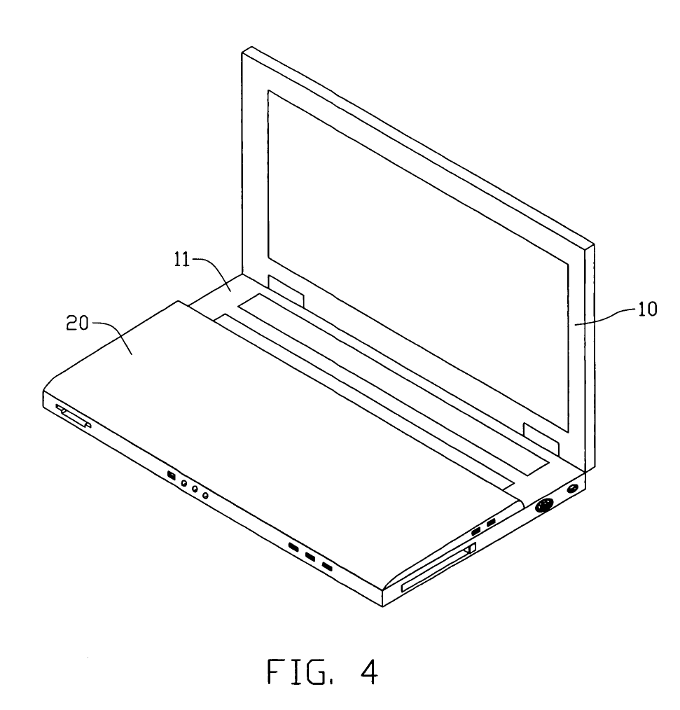

The lid 114 typically covers the recess 115 of the base unit 11. In need of using the docking station 20, the lid 114 is removed from the recess 115 to expose the connector 113. The docking station 20 is placed on the base unit 11, and the connector 21 of the docking station 20 is inserted into the recess 115 and connected with the connector 113 of the base unit 11, as shown in FIG. 4. The portable computer can thus communicate with more peripheral equipment via the docking station 20.

The connector 113 of the base unit 11 can also be directly connected to peripheral equipment, such as a mouse and a modem.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A portable computer comprising:
a cover unit;
a base unit connectable to the cover unit; and
a connector disposed in a top portion of the base unit and accessible from a top surface of the base unit configured for electrically connecting with an external device.

2. The portable computer as claimed in claim 1, wherein the top portion of the base unit defines a recess, and the connector of the base unit is exposed in the recess.

3. The portable computer as claimed in claim 2, further comprising a lid removably covering the recess of the top portion of the base unit.

4. A portable computer assembly comprising:
a cover unit;
a base unit connected to the cover unit;
a connector disposed on a top portion of the base unit and accessible from a top surface of the base unit; and
a docking station removably connected to the base unit via the connector, the docking station including a plurality of expansion ports configured for connecting peripheral equipments.

5. The portable computer assembly as claimed in claim 4, wherein the top portion of the base unit defines a recess, and the connector of the base unit is formed in the recess of the top portion.

6. The portable computer assembly as claimed in claim 5, wherein a connector protrudes from a bottom of the external device for being connected with the connector of the base unit.

7. The portable computer assembly as claimed in claim 5, wherein a lid is provided to removably cover the recess of the top portion of the base unit.

8. The portable computer assembly as claimed in claim 4, wherein the docking station is supported on the top portion, in contact with the top surface of the base unit.

9. A portable computer comprising:
a base unit having a top side, the top side being configured so as to support a docking station thereon for enhancing expandability of the portable computer, the docking station including a first connector on a bottom thereof; and
a second connector disposed in the top side of the base unit, the second connector being configured for being electrically connected with the first connector once the docking station is supported on the top side.

10. The portable computer of claim 9, wherein the top side defines a recess therein, and the second connector is exposed in the recess.

11. The portable computer of claim 10, further comprising a lid to removably cover the recess when the docking station is removed.

12. The portable computer of claim 9, further comprising a cover unit rotatably coupled to the base unit.
